(19) United States
(12) Patent Application Publication
(10) Pub. No.: US 2026/0368015 A1
(43) Pub. Date: Nov. 19, 2026

(54) POOR INFORMATION FAULT PREDICTION METHOD BASED ON MULTI-DOMAIN FEATURE FUSION AND INTERPRETABLE ADVERSARIAL CONVOLUTIONAL ENCODING NETWORK

(71) Applicant: Guangdong University Of Technology, Guangzhou (CN)

(72) Inventors: Zhuyun CHEN, Guangzhou (CN); Hongqi LIN, Guangzhou (CN); Youpeng GAO, Guangzhou (CN); Qiang LIU, Guangzhou (CN); Zehao LI, Guangzhou (CN); Shuai MA, Guangzhou (CN)

(73) Assignee: Guangdong University Of Technology, Guangzhou (CN)

(21) Appl. No.: 19/557,154

(22) Filed: Mar. 5, 2026

(30) Foreign Application Priority Data
Apr. 30, 2025 (CN) 2025105642883

(51) Int. Cl. G06F 11/07

(52) U.S. Cl. CPC G06F 11/0751; G06F 11/0709

(57) ABSTRACT

Disclosed is a poor information fault prediction method based on multi-domain feature fusion and an interpretable adversarial convolutional encoding network, including: collecting a vibration signal of target rotating machinery; and inputting the vibration signal into a preset fault prediction model and outputting a fault category. The fault category includes a known fault category and a new fault category, the fault prediction model is obtained based on training set training, the training set includes fault samples of a plurality of rotating machinery under multiple operating conditions, and the fault prediction model is constructed by combining multi-domain feature fusion and the interpretable adversarial convolutional encoding network. The method focuses on new fault categories that may appear in rotating machinery in a complex industrial environment, improves reliability of fault diagnosis under a condition of small sample data, and comprehensively coordinates and optimizes a fault diagnosis process and model performance.

### CROSS-REFERENCE TO RELATED APPLICATIONS

The application claims priority to Chinese patent application No. 2025105642883, filed on Apr. 30, 2025, the entire contents of which are incorporated herein by reference.

### TECHNICAL FIELD

The present disclosure relates to the technical field of intelligent fault diagnosis of rotating machinery, particularly to a poor information fault prediction method based on multi-domain feature fusion and an interpretable adversarial convolutional encoding network.

### BACKGROUND

With the rapid development of modern industrial technology, the automation, intelligence, and high-precision levels of mechanical equipment are continuously improving, the structure of rotating machinery is becoming increasingly complex, and the operating speed and load capacity of the rotating machinery are also significantly increased. However, during long-term operation, components of the rotating machinery are easily affected by factors such as friction, impact, and fatigue, thereby generating damages such as wear, crack, and deformation. If the damages are not detected and processed in time, serious equipment faults may be caused, and even safety accidents may be triggered. Therefore, in order to ensure stable and efficient operation of industrial equipment, identifying a potential fault accurately and taking a maintenance measure place higher requirements on intelligent fault diagnosis technology and health monitoring of a mechanical system.

Traditional fault diagnosis methods rely on signal processing, feature extraction, and pattern recognition technologies, require in-depth mechanism analysis, and rely on expert experience and prior knowledge. With the development of artificial intelligence technology, intelligent fault diagnosis based on deep learning has become a research hotspot, showing significant advantages. Deep learning is an artificial intelligence method based on a multi-layer neural network, and the core idea of deep learning is simulating the layered structure of a human brain, and automatically learning features and latent patterns from data through models such as a deep neural network, a convolutional neural network, and a recurrent neural network. Compared with traditional methods, deep learning can directly extract effective information from raw data without complex signal mechanism analysis, thereby reducing human intervention and improving accuracy and generalization ability of diagnosis. In recent years, the intelligent fault diagnosis method based on deep learning has been widely applied to condition monitoring and fault prediction of the rotating machinery, and has achieved significant results.

However, in an actual industrial environment, due to complex operating conditions of the rotating machinery, fault types of the rotating machinery present diversity and uncertainty. Although some fault modes have a possibility of occurrence, due to the rarity of the fault modes, the fault modes often have not appeared or been recorded in historical data. Due to the imbalance of data distribution and the unpredictability of new faults, methods based on supervised learning rely on a large amount of labeled historical data, but for unseen new faults, a model lacks adaptability, and detecting unknown faults effectively is difficult. In addition, current methods based on deep learning such as supervised learning, transfer learning, and few-shot learning improve the generalization ability of the model to a certain extent, but mainly aim at improving the diagnosis accuracy of the model for known fault categories, ignore some objective condition limitations and practical demands to a certain extent, lead to problems in diagnosing new fault categories, often have unsatisfactory effects, and still have certain limitations.

### SUMMARY

Provided in the present disclosure is a poor information fault prediction method based on multi-domain feature fusion and an interpretable adversarial convolutional encoding network. The method focuses on new fault categories that may appear in rotating machinery in a complex industrial environment, improves reliability of fault diagnosis under a condition of small sample data, and comprehensively coordinates and optimizes a fault diagnosis process and model performance.

To achieve the above object, the present disclosure provides the following solution:

A poor information fault prediction method based on multi-domain feature fusion and an interpretable adversarial convolutional encoding network, including: collecting a vibration signal of target rotating machinery; and inputting the vibration signal into a preset fault prediction model and outputting a fault category, where the fault category includes a known fault category and a new fault category, the fault prediction model is obtained based on training set training, the training set includes fault samples of a plurality of rotating machinery under multiple operating conditions, and the fault prediction model is constructed by combining multi-domain feature fusion and the interpretable adversarial convolutional encoding network.

Optionally, before training the fault prediction model based on the training set, the method further includes performing preprocessing on the training set, where performing the preprocessing includes: performing segmentation on the collected fault samples; and performing normalization.

Optionally, the fault prediction model includes: a new fault detection module configured to perform multi-scale feature fusion on input data based on an autoencoder, obtain encoded data, and input the encoded data into a decoder to output decoded data, where the autoencoder is constructed using a wavelet scattering transform with different scales and a convolution module, and the decoder is constructed using a deconvolution module with different scales; a known fault diagnosis module configured to input the encoded data into a classifier and output a prediction vector, where the classifier is constructed by a fully connected neural network; a cooperative adversarial module configured to input the encoded data and the decoded data into a discriminator and perform model optimization using an adversarial training strategy; and a fault output module configured to calculate a reconstruction error between the input data and the decoded data, and determine the fault category based on the reconstruction error, where if the reconstruction error reaches a preset threshold, determining as the new fault category, and if the reconstruction error does not reach the preset threshold, determining as a known fault category corresponding to a maximum component in the prediction vector.

Optionally, the encoded data is:

$$E ( x ) = \frac{1}{{J}_{E}} {\sum }_{j = 1}^{{J}_{E}} {F}_{C}^{( j )} ( {F}_{S}^{( j )} ( x ) )$$

where E represents the autoencoder, x represents the input data, E(x) represents the encoded data,

$${F}_{S}^{( j )}$$

and

$${F}_{C}^{( j )}$$

represent the wavelet scattering transform and the convolution module having j-th scale information respectively, and J_{E} represents a number of scales included in the autoencoder.

Optionally, the decoded data is:

$$D ( E ( x ) ) = \frac{1}{{J}_{D}} {\sum }_{k = 1}^{{J}_{D}} {F}_{T C}^{( k )} ( E ( x ) ) = \frac{1}{{J}_{D}} {\sum }_{k = 1}^{{J}_{D}} {F}_{T C}^{( k )} ( \frac{1}{{J}_{E}} {\sum }_{j = 1}^{{J}_{E}} {F}_{C}^{( j )} ( {F}_{S}^{( j )} ( x ) ) ) ;$$

where D represents the decoder, D(E(x)) represents the decoded data,

$${F}_{T C}^{( k )}$$

represents the deconvolution module having k-th scale information, and J_{D} represents a number of scales included in the decoder.

Optionally, an objective function for performing the model optimization using the adversarial training strategy is:

$${Obj}_{ae , dsc} = \frac{1}{m} {\sum }_{i = 1}^{m} \frac{1}{{J}_{D}} {\sum }_{k = 1}^{{J}_{D}} {L}_{a e} ( {x}_{i} , {F}_{T C}^{( k )} ( E ( {x}_{i} ) ) ) - {L}_{d s c} ( {P}_{E} ( E ( {x}_{i} ) ) , 1 ) - {L}_{d s c} ( {P}_{E} ( {x}_{i}^{z} ) , 0 ) - {L}_{d s c} ( {P}_{D} ( D ( E ( {x}_{i} ) ) ) , 1 ) - {L}_{d s c} ( {P}_{D} ( D ( {x}_{i}^{z} ) ) , 0 ) ;$$

where E, D, P_{E}, and P_{D} represent the autoencoder, the decoder, the encoding discriminator, and the decoding discriminator respectively;

$${F}_{T C}^{( k )}$$

represents the deconvolution module having k-th scale information; J_{D} represents a number of scales included in the decoder; Lₐₑ is a mean squared error loss function used by the autoencoder; L_{dsc} is a binary cross-entropy loss function used by the discriminator; xᵢ represents i-th input data; m represents a total number of input data; E(xᵢ) and

$${x}_{i}^{z}$$

represent encoded data and pseudo encoded data of the i-th input data respectively; and D(E(xᵢ)) and

$$D ( {x}_{i}^{z} )$$

represent decoded data and pseudo decoded data of the i-th input data respectively.

Optionally, optimizing the autoencoder is represented as:

$${θ}_{a e} , {b}_{a e} = {arg min}_{{θ}_{a e} , {b}_{ae}} \frac{1}{m} {\sum }_{i = 1}^{m} \frac{1}{{J}_{D}} {\sum }_{k = 1}^{{J}_{D}} {L}_{a e} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ;$$

where θₐₑ and bₐₑ represent various weights and bias parameters involved in the autoencoder respectively.

Optionally, optimizing the discriminator is represented as:

$${θ}_{d s c} , {b}_{d s c} = {arg max}_{{θ}_{dsc} , {b}_{dsc}} \frac{1}{m} {\sum }_{i = 1}^{m} \frac{1}{{J}_{D}} {\sum }_{k = 1}^{{J}_{D}} {L}_{a e} ( {x}_{i} , {F}_{TC}^{( k )} ( E ( {x}_{i} ) ) ) - {L}_{d s c} ( {P}_{E} ( E ( {x}_{i} ) ) , 1 ) - {L}_{d s c} ( {P}_{E} ( {x}_{i}^{z} ) , 0 ) - {L}_{d s c} ( {P}_{D} ( D ( E ( {x}_{i} ) ) ) , 1 ) - {L}_{d s c} ( {P}_{D} ( D ( {x}_{i}^{z} ) ) , 0 ) ;$$

where θ_{dsc} and b_{dsc} represent various weights and bias parameters included in the discriminator respectively.

Optionally, optimizing the classifier is represented as:

$${θ}_{cls} , {b}_{c l s} = {arg min}_{{θ}_{cls} , {b}_{cls}} \frac{1}{m} {\sum }_{i = 1}^{m} {L}_{c l s} ( C ( E ( {x}_{i} ) ) , {y}_{i} ) ;$$

where C represents the classifier, θ_{cls} and b_{cls} represent various weights and bias parameters included in the classifier respectively, Lets is a cross-entropy loss function used by the classifier, C(E(xᵢ)) represents a predicted category of the i-th input data, and yᵢ represents a true category of the i-th input data.

The beneficial effects of the present disclosure are: The present disclosure focuses on the new fault categories that may appear in the rotating machinery in the complex industrial environment, and takes accurate identification of the new fault category as a basis for fault diagnosis technology improvement; the present disclosure improves the reliability of fault diagnosis under the condition of small sample data, and takes enhancing a learning ability of the model for small sample new fault data as one of key directions of technical optimization, because in an actual industrial scenario, obtaining a large amount of fault sample data is difficult, and small sample diagnosis ability is crucial; and the present disclosure comprehensively coordinates and optimizes the fault diagnosis process and the model performance, including improving diagnosis efficiency, reducing a misdiagnosis rate, and enhancing a generalization ability of the model.

### BRIEF DESCRIPTION OF DRAWINGS

To describe the technical solutions in the embodiments of the present disclosure or in the prior art more clearly, the accompanying drawings required for describing the embodiments are briefly introduced below. Apparently, the accompanying drawings in the following description show merely some embodiments of the present disclosure, and a person of ordinary skill in the art may still derive other drawings from these accompanying drawings without creative efforts.

FIG. 1 is a flowchart of a poor information fault prediction method based on multi-domain feature fusion and an interpretable adversarial convolutional encoding network according to an embodiment of the present disclosure.

FIG. 2 is a structural diagram of a fault prediction model according to an embodiment of the present disclosure.

FIG. 3 is a parameter diagram of an autoencoder and a decoder according to an embodiment of the present disclosure.

FIG. 4 is a schematic diagram of test accuracy obtained by the present method and a comparison method under different operating conditions according to an embodiment of the present disclosure.

FIG. 5 is a schematic diagram of ablation experiment results of the present method and the comparison method according to an embodiment of the present disclosure.

### DETAILED DESCRIPTION OF THE EMBODIMENTS

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the scope of protection of the present disclosure.

To make the above object, features, and advantages of the present disclosure more obvious and easy to understand, the present disclosure is further described in detail below with reference to the accompanying drawings and the detailed description.

Provided in this embodiment is a poor information fault prediction method based on multi-domain feature fusion and an interpretable adversarial convolutional encoding network. The method includes:
collecting a vibration signal of target rotating machinery; and
inputting the vibration signal into a preset fault prediction model and outputting a fault category, where the fault category includes a known fault category and a new fault category, the fault prediction model is obtained based on training set training, the training set includes fault samples of a plurality of rotating machinery under multiple operating conditions, and the fault prediction model is constructed by combining multi-domain feature fusion and the interpretable adversarial convolutional encoding network.

Specifically, before training the fault prediction model based on the training set, the method further includes performing preprocessing on the training set, and performing the preprocessing includes:
performing segmentation on the collected fault samples, and performing normalization.

Further, the fault prediction model includes:
a new fault detection module configured to perform multi-scale feature fusion on input data based on an autoencoder, obtain encoded data, and input the encoded data into a decoder to output decoded data, where the autoencoder is constructed using a wavelet scattering transform with different scales and a convolution module, and the decoder is constructed using a deconvolution module with different scales;
a known fault diagnosis module configured to input the encoded data into a classifier and output a prediction vector, where the classifier is constructed by a fully connected neural network;
a cooperative adversarial module configured to input the encoded data and the decoded data into a discriminator and perform model optimization using an adversarial training strategy; and
a fault output module configured to calculate a reconstruction error between the input data and the decoded data, and determine the fault category based on the reconstruction error, where if the reconstruction error reaches a preset threshold, determining as the new fault category, and if the reconstruction error does not reach the preset threshold, determining as a known fault category corresponding to a maximum component in the prediction vector.

Specifically, this embodiment focuses on the new fault categories that may appear in the rotating machinery in a complex industrial environment, and takes accurate identification of the new fault category as a basis for fault diagnosis technology improvement; this embodiment improves reliability of fault diagnosis under a condition of small sample data, and takes enhancing a learning ability of the model for small sample new fault data as one of key directions of technical optimization, because in an actual industrial scenario, obtaining a large amount of fault sample data is difficult, and small sample diagnosis ability is crucial; and this embodiment comprehensively coordinates and optimizes a fault diagnosis process and model performance, including improving diagnosis efficiency, reducing a misdiagnosis rate, and enhancing a generalization ability of the model.

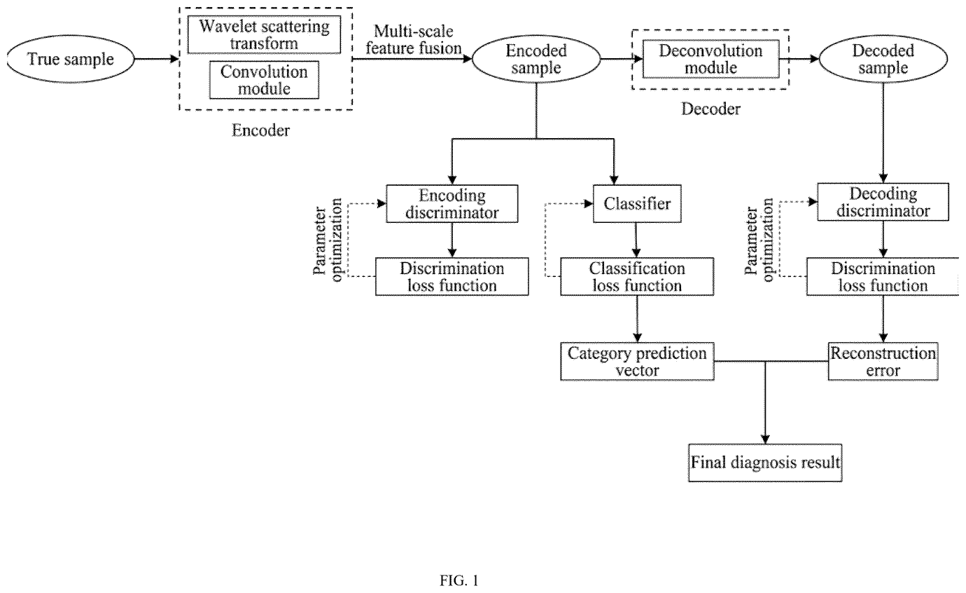

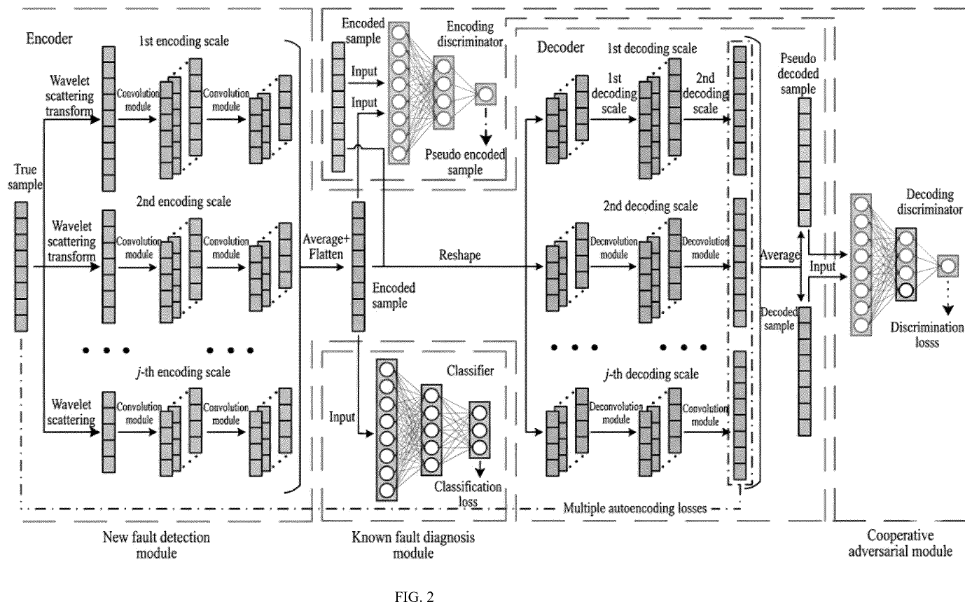

The fault prediction model constructed in this embodiment is described in detail below with reference to FIG. 1. Construction, training optimization, and test application of the model specifically include the following steps:
Step S1: Collect a raw vibration signal of the rotating machinery under a specific experimental operating condition, perform normalization on the fault samples obtained under different operating conditions, and then perform labeling to construct a complete dataset.
Step S2: Construct a poor information new fault diagnosis model (ME-DACAE) based on the multi-domain feature fusion and the interpretable adversarial convolutional encoding network for new fault detection under a small sample, as shown in FIG. 2. A network framework includes: the new fault detection module based on a multi-scale autoencoder, the cooperative adversarial module based on a double discriminator, the known fault diagnosis module based on a fully connected classifier, and the fault output module.
Step S3: In a training stage, perform multi-scale data augmentation on training samples using the wavelet scattering transform with different set scale parameters, further extract features from the augmented training samples on each scale using the convolution module, and calculate an average value of the extracted features on each scale simultaneously to implement feature fusion.
Step S4: Input the fused features and randomly generated pseudo encoded samples into an encoding discriminator, the classifier, and the multi-scale deconvolution module of the decoder; obtain decoded samples and pseudo decoded samples by calculating an average value of decoding reconstruction of the deconvolution module with each scale; and input the decoded samples and the pseudo decoded samples into a decoding discriminator.
Step S5: In an optimization stage, calculate losses of samples on the autoencoder, the classifier, the encoding discriminator, and the decoding discriminator; adopt a gradient descent algorithm; optimize model parameters alternately by combining the adversarial training strategy; and complete training of an overall model after multiple rounds of iterations.
Step S6: In a testing stage, calculate a reconstruction error between a test sample and a decoded sample; if the error is greater than or equal to a preset threshold, determine as the new fault category; and otherwise, determine as a known category corresponding to the maximum component in the prediction vector.

Further, in Step S1, the dataset is derived from a laboratory experimental platform or an actual industrial environment equipment monitoring platform.

Collecting data under multiple operating conditions further includes: performing preprocessing on the collected data, that is, performing segmentation on the collected dataset, and normalizing the obtained sample set to between [−1, 1], which is suitable for input of a network model.

Further, the new fault detection module constructed in Step S2 adopts an autoencoder and decoder structure. The convolution module in the autoencoder is formed by stacking a convolutional layer, an activation layer, a pooling layer, etc. sequentially. The deconvolution module in the decoder is formed by stacking a deconvolutional layer, an activation layer, an unpooling layer, etc. sequentially. The cooperative adversarial module constructs the encoding discriminator and the decoding discriminator to enhance a training effect of a convolutional autoencoder. The known fault diagnosis module is constructed using the fully connected neural network, and a Softmax activation function is adopted in a last layer of the known fault diagnosis module.

Further, Step S3 specifically includes:

For the raw fault signal data x received in Step S1, set multiple scale parameters j=1, 2, . . . , J, and perform a multi-scale wavelet scattering transform on the raw sample x. When performing this transform on the sample, a scaling function φ and multiple groups of wavelet functions ψ={ψ_{λ}_{₁}, ψ_{λ}_{₂}, . . . , ψ_{λ}_{ₘ}} need to be used, wherein ψ_{λ} represents a wavelet function set obtained by passing a raw mother wavelet through a series of dilation transforms. First, perform a wavelet transform on the sample x using a wavelet function ψ_{λ1} at a zeroth layer, obtain what is called a wavelet coefficient and take a modulus, to obtain a first layer of the wavelet scattering transform, represented as:

L₁=|x*ψ_{λ}_{₁}| (1);

Continue to perform a convolution operation on the wavelet coefficient of the first layer using ψ_{λ2}, and take a modulus of a newly obtained wavelet coefficient, to obtain a second layer, which is represented as:

L₂=|x*ψ_{λ}_{₁}|*ψ_{λ}_{₂}| (2);

By parity of reasoning, after m layers, a final output of the wavelet scattering transform can be obtained. The output is called a scattering coefficient, and its expression is as follows:

$$S = [ \begin{matrix}{S}_{0} \\ {S}_{1} \\ ⋮ \\ {S}_{m}\end{matrix} ] = [ \begin{matrix}{L}_{0} * ϕ \\ {L}_{1} * ϕ \\ ⋮ \\ {L}_{m} * ϕ\end{matrix} ] = [ \begin{matrix}x * ϕ \\ \vert \vert x * {ψ}_{{λ}_{1}} \vert * {ψ}_{{λ}_{2}} \vert * ϕ \\ ⋮ \\ \vert \vert x * {ψ}_{{λ}_{1}} \vert * {ψ}_{{λ}_{2}} \vert * … * {ψ}_{{λ}_{m}} \vert * ϕ\end{matrix} ] ; \qquad ( 3 )$$

wherein the zeroth layer L₀ represents the raw sample, and the scattering coefficient S is a deep feature extracted after performing the wavelet scattering transform on the sample x. The used scaling function has an adjustable scale parameter. Multi-scale data augmentation is implemented by setting multiple scale parameters. Finally, the scattering coefficients are concatenated to obtain a scattering sample.

For scattering samples on different scales, a multi-layer convolution module is designed to further extract deep features of the samples, while ensuring that same feature dimensions are obtained after passing through the multi-layer convolution module. Afterward, an average value of the extracted features on each scale is calculated to implement multi-scale feature fusion, and the fused features are used as an encoded feature (encoded sample) of the raw sample. For the raw sample x, a total of J_{E} scales are adopted in the autoencoder, and the encoded feature of the sample x can be represented as:

$$E ( x ) = \frac{1}{{J}_{E}} {\sum }_{j = 1}^{{J}_{E}} {F}_{C}^{( j )} ( {F}_{S}^{( j )} ( x ) ) ; \qquad ( 4 )$$

wherein E represents the autoencoder, and

$$D ( E ( x ) ) = \frac{1}{{J}_{D}} {\sum }_{k = 1}^{{J}_{D}} {F}_{TC}^{( k )} ( E ( x ) ) = \frac{1}{{J}_{D}} {\sum }_{k = 1}^{{J}_{D}} {F}_{TC}^{( k )} ( \frac{1}{{J}_{E}} {\sum }_{j = 1}^{{J}_{E}} {F}_{C}^{( j )} ( {F}_{S}^{( j )} ( x ) ) ) \qquad ( 5 )$$

represent the wavelet scattering transform and the convolution module having j-th scale information respectively.

Further, in Step S4, multiple deconvolution modules with different convolution parameters are designed in the decoder to decode the encoded features respectively to reconstruct the raw sample. A final decoded sample is obtained by calculating an average value of each reconstructed sample, and the decoded sample can be represented as:

$${F}_{S}^{( j )} and {F}_{C}^{( j )}$$

wherein D represents the decoder, and

$${F}_{TC}^{( k )}$$

represents the deconvolution module having k-th scale information.

An adversarial training strategy is introduced to enhance a training effect of the autoencoder. Two discriminators based on a fully connected neural network are constructed, which are an encoding discriminator and a decoding discriminator respectively. Both are used to assist the autoencoder to implement adversarial training.

Input of the encoding discriminator includes the encoded sample of the training sample and some randomly generated auxiliary samples (called pseudo encoded samples). Features of the pseudo encoded sample follow a normal distribution with a value range between [−1, 1]. On the other hand, input of the decoding discriminator includes the decoded sample of the training sample and an output obtained after decoding the pseudo encoded sample (called a pseudo decoded sample). For a dataset

$$A = {\{ ( {x}_{i} , {y}_{i} ) \}}_{i = 1}^{m}$$

containing m known category samples, wherein xᵢ and yᵢ represent an i-th sample in the dataset and a corresponding true category label respectively. A discrimination label for the encoded sample is set to 1; and the pseudo encoded sample is obtained by random generation and set to 0. An objective function in a process of the adversarial training can be defined as:

$${Obj}_{ae , dsc} = \frac{1}{m} {\sum }_{i = 1}^{m} \frac{1}{{J}_{D}} {\sum }_{k = 1}^{{J}_{D}} {L}_{ae} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ; \qquad ( 6 )$$

wherein E, D, P_{E}, P_{D} represent the autoencoder, the decoder, the encoding discriminator, and the decoding discriminator respectively;

$${F}_{TC}^{( k )}$$

represents the deconvolution module having the k-th scale information; J_{D} represents a number of scales included in the decoder; Lₐₑ is a Mean Squared Error (MSE) loss function used by the autoencoder; L_{dsc} is a binary cross-entropy loss function used by the two discriminators; xᵢ represents i-th input data; m represents a total number of input data; E(xᵢ) and

$${x}_{i}^{z}$$

represent encoded data and pseudo encoded data of the i-th input data respectively; and D(E(xᵢ)) and

$$D ( {x}_{i}^{z} )$$

represent decoded data and pseudo decoded data of the i-th input data respectively.

Further, in Step S5 optimization stage, for output of the decoder of S4 that should reproduce the raw sample as much as possible, the objective function of the autoencoder can be defined as:

$${Obj}_{ae} = \frac{1}{m} \frac{1}{{J}_{D}} {\sum }_{i = 1}^{m} {\sum }_{k = 1}^{{J}_{D}} {L}_{ae} ( {x}_{i} , {\hat{x}}_{i}^{( k )} ) ; \qquad ( 7 )$$

wherein xᵢ and m represent the i-th sample in the training set and the total number of samples respectively,

$${\hat{x}}_{i}^{( k )}$$

represents a decoded sample obtained by reconstructing the sample xᵢ on a k-th scale, and Lₐₑ is the MSE loss function. Training of the autoencoder is implemented by minimizing the objective function, and the process is represented as:

$${θ}_{ae} , {b}_{ae} = {arg min}_{{θ}_{ae} , {b}_{ae}} \frac{1}{m} \frac{1}{{J}_{D}} {\sum }_{i = 1}^{m} {\sum }_{k = 1}^{{J}_{D}} {L}_{ae} ( {x}_{i} , {\hat{x}}_{i}^{( k )} ) ; \qquad ( 8 )$$

wherein θₐₑ and bₐₑ represent various convolutional weights and bias parameters involved in the autoencoder respectively.

The autoencoder and the two discriminators should be trained and optimized alternately. When training the autoencoder, parameters of the discriminators need to be fixed, and parameters of the autoencoder are optimized by minimizing the objective function formula (6). The process can be represented as:

$${θ}_{ae} , {b}_{ae} = {arg min}_{{θ}_{ae} , {b}_{ae}} \frac{1}{m} {\sum }_{i = 1}^{m} \frac{1}{{J}_{D}} {\sum }_{k = 1}^{{J}_{D}} {L}_{ae} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ; \qquad ( 9 )$$

wherein θₐₑ and bₐₑ represent various weights and bias parameters involved in the autoencoder respectively. Conversely, when training the discriminators, the parameters of the autoencoder need to be fixed, and the parameters of the discriminators are updated by maximizing the objective function formula (6), as shown in the following formula:

$${θ}_{dsc} , {b}_{dsc} = {arg min}_{{θ}_{dsc} , {b}_{dsc}} \frac{1}{m} {\sum }_{i = 1}^{m} \frac{1}{{J}_{D}} {\sum }_{k = 1}^{{J}_{D}} {L}_{ae} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ; \qquad ( 10 )$$

wherein θ_{dsc} and b_{dsc} are various weights and bias parameters included in the discriminators respectively. The process of alternate optimization described above is repeated multiple times to complete the adversarial training and effectively improve new fault detection performance of the proposed method.

For optimization of the classifier, for the dataset

$$A = {\{ ( {x}_{i} , {y}_{i} ) \}}_{i = 1}^{m}$$

containing m known category samples, wherein xᵢ and yᵢ represent the i-th sample in the dataset and the corresponding category label respectively. In a process of classifier training, an objective function can be defined as:

$${Obj}_{cls} = \frac{1}{m} {\sum }_{i = 1}^{m} {L}_{cls} ( C ( E ( {x}_{i} ) ) , {y}_{i} ) ; \qquad ( 11 )$$

wherein E and C represent the encoder and the classifier respectively, and L_{cls} is a classifier cross-entropy loss function. Training of the classifier is completed by minimizing the objective function, and the process is represented as:

$${θ}_{cls} , {b}_{cls} = {arg min}_{{b}_{cls} , {θ}_{cls}} \frac{1}{m} {\sum }_{i = 1}^{m} {L}_{cls} ( C ( E ( {x}_{i} ) ) , {y}_{i} ) ; \qquad ( 12 )$$

wherein θ_{cls} and b_{cls} represent various weights and bias parameters involved in the classifier respectively. Further, by combining formulas (10), (11), and (12), a training optimization expression of the entire model can be obtained:

$$( 13 )$$

$${θ}_{ae} , {b}_{ae} , {θ}_{cls} , {b}_{cls} , {θ}_{dsc} , {b}_{dsc} = arg {min}_{\begin{matrix}{θ}_{ae} , {b}_{ae} , \\ {θ}_{cls} , {b}_{cls}\end{matrix}} {max}_{\begin{matrix}{θ}_{dsc} , \\ {b}_{dsc}\end{matrix}} \frac{1}{m} {\sum }_{i = 1}^{m} [ \begin{matrix}\frac{1}{{J}_{D}} {\sum }_{k = 1}^{{J}_{D}} {L}_{ae} ( {x}_{i} , {F}_{TC}^{( k )} ( E ( {x}_{i} ) ) ) + \\ {L}_{cls} ( C ( E ( {x}_{i} ) ) , {y}_{i} ) - {L}_{dsc} ( {P}_{E} ( E ( {x}_{i} ) ) , 1 ) - \\ {L}_{dsc} ( {P}_{E} ( {x}_{i}^{z} ) , 0 )\end{matrix} ] - {L}_{dsc} ( {P}_{D} ( D ( E ( {x}_{i} ) ) ) , 1 ) - {L}_{dsc} ( {P}_{D} ( D ( {x}_{i}^{z} ) ) , 0 )$$

Further, in the testing stage of Step S6, when training of the proposed method is completed, in the testing stage, the autoencoder and the classifier will output a decoded sample and a prediction vector for each test sample respectively. Then, a reconstruction error δ between a test sample and the decoded sample is calculated using the MSE function, and is compared with a set detection threshold φ. If δ≥φ, the test sample is considered as a new fault category; and if δ<φ, the test sample is regarding as a known category (health or known fault category), and a category corresponding to a maximum component in the prediction vector is a specific category to which the test sample belongs, implementing small sample new fault detection and known fault diagnosis of the rotating machinery.

Comparative experimental verification of the method proposed in this embodiment is described below:

### 1. Experiment Introduction:

An automotive Five-Speed Transmission (FST) dataset is used to design related experiments. The FST dataset is collected from an automotive transmission system experimental platform. Acceleration sensors are installed on a five-speed transmission of the experimental platform. Vibration signal data is collected at a sampling frequency of 24 kHz under 3 operating conditions where a load of the transmission is constant at 50 Nm and input shaft rotational speeds are 750, 1000, and 1250 rpm respectively. The FST dataset contains bearing fault data, gear fault data, and compound fault data of the two. Covered transmission states include health, a 0.2 mm bearing Inner Ring (IR) cracking fault, a gear single Gear Tooth (GT) fracture fault, and a Compound Fault (CF) of the two, totaling 4 types, which are represented by category 1 to category 4 respectively. The health, the IR fault, and the GT fault are regarding as known categories on the transmission, while the CF fault is considered as an unknown new fault category. Faults are implanted by wire cutting. A 0.2 mm crack is processed on a bearing inner ring to simulate a bearing cracking fault, and a gear tooth is cut to simulate a gear broken tooth fault.

Samples are collected using a non-overlapping sliding window on a time-domain vibration signal provided by the FST dataset. For each category of data, 450 samples (150 for each operating condition) with a length of 4096 are collected. 1-shot, 2-shot, and 5-shot small sample new fault detection tasks are designed under the 3 operating conditions respectively. 1, 2, and 5 samples of each category in the known categories are randomly selected for training, and 50 samples of each category in the known categories other than the training samples are also selected to form a test set together with all samples of the new fault category. The test set of each task contains 150 known category samples and 150 new fault category samples. A goal of the task aims to achieve accurate distinction between these two major categories.

### 2. Method Verification:

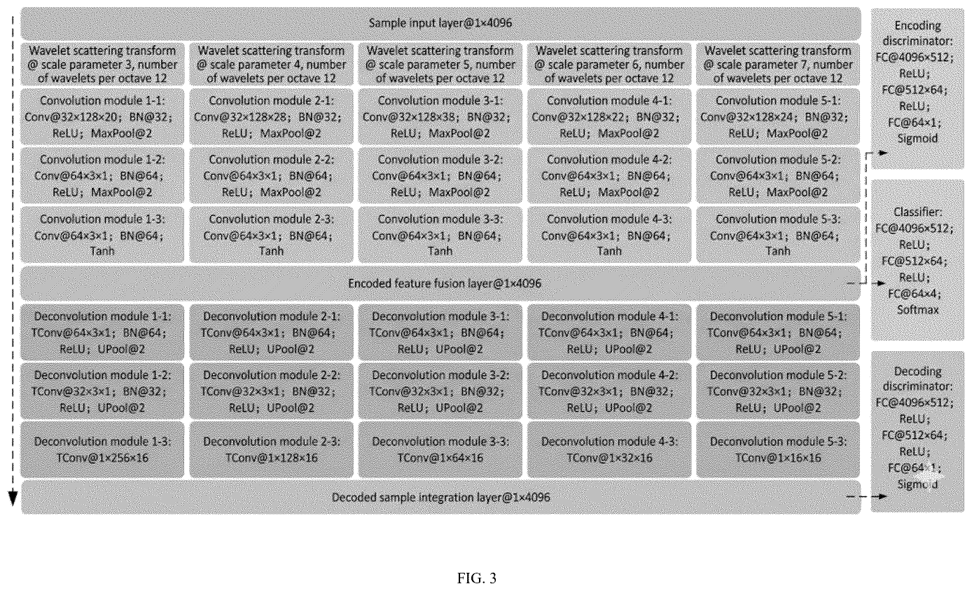

Parameters of the constructed multi-domain feature fusion and interpretable adversarial convolutional encoding network are shown in Table 1 and FIG. 3:

TABLE 1

| Training Process | | Integrated Model | |
|---|---|---|---|
| Hyperparameter | Set Value | Hyperparameter | Set Value |
| Number of iterations | 300 | Encoding scale | 5 |
| Learning rate | 1e−5 | Decoding scale | 5 |
| Batch size | 64 | Number of convolution | 3 |
| | | modules for each scale | |
| Optimizer | Adam | Number of deconvolution | 3 |
| | | modules for each scale | |
| Initialization | Random | Detection threshold | 1.5 |
| method | initialization | | |

### (1) Comparison Between the Method of the Present Disclosure and Other Fault Diagnosis Methods:

In engineering practice, the model is required not only to accurately detect the new fault category, but also to implement further fault distinction on the known category. On one hand, confusion between the health and the known fault category is prevented; and on the other hand, a fault location can be quickly locating when the model identifies a known fault. Comparison methods selected in this experiment include a Multi-Task AutoEncoder (MTAE), a Multi-Task Convolutional AutoEncoder (MTCAE), a Multi-Task AutoEncoder+Fine-Tuning (MTAE-FT), and a Multi-Task Convolutional AutoEncoder+Fine-Tuning (MTCAE-FT), totaling 4 types. All are multi-task models and can perform the new fault detection and the known fault diagnosis simultaneously. In addition, the health, the IR fault, and the GT fault are regarding as the known categories, while the CF fault is considered as the unknown new fault category. Then, the 1-shot, 2-shot, and 5-shot small sample new fault detection and known fault diagnosis tasks are designed under the 3 operating conditions respectively. 1, 2, and 5 samples of each category in the known categories are randomly selected for training, and remaining samples form the test set together with all samples in the new fault category. For methods based on transfer learning such as the MTAE-FT and the MTCAE-FT, additional source domain data is provided to assist in training. Since the FST dataset covers data under 3 different operating conditions, when data under a certain operating condition is designated as a target domain, data under other 2 operating conditions will be used to construct a source domain. According to the above settings, a number of samples used by each method in one diagnosis task is shown in Table 2.

TABLE 2

| | Number of Training Samples | | Number of Test Samples | |
|---|---|---|---|---|
| | for Each Category | | for Each Category | |
| | Source Domain | Target Domain | Target Domain | |
| | Known Category | Known Category | Known Category | Target Domain |
| Comparison | (Total 3 | (Total 3 | (Total 3 | New Fault |
| Method | Categories) | Categories) | Categories) | Category |
| MTAE | — | 1/2/5 | 149/148/145 | 150 |
| MTCAE | — | 1/2/5 | 149/148/145 | 150 |
| MTAE-FT | 150 | 1/2/5 | 149/148/145 | 150 |
| MTCAE-FT | 150 | 1/2/5 | 149/148/145 | 150 |
| ME-DACAE | — | 1/2/5 | 149/148/145 | 150 |

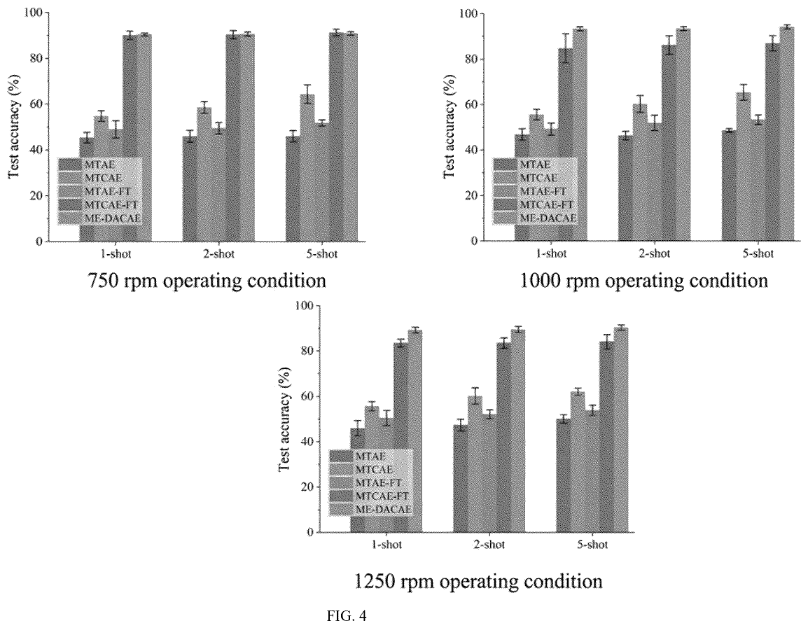

Test accuracy obtained by each method is shown in FIG. 4. Experimental results show that test accuracy of the MTAE in a small sample variable operating condition fault diagnosis task is only about 50%, and the improved version MTAE-FT also fails to improve significantly (lower than 55%). Although the MTAE has a high F1 score in the new fault detection task, performance in detailed distinction of the known categories is poor, mainly because feature extraction capability of the encoder based on the fully connected layer is limited, identifying fault features effectively is difficult, and classification performance is affected. In contrast, test accuracy of the MTCAE and the MTCAE-FT using a convolutional layer encoder is significantly better than that of an MTAE series. In a 1-shot task under a 750 rpm operating condition, the test accuracy of the MTCAE-FT reaches 90.16%, which is 41.18% higher than that of the MTAE-FT, highlighting a feature extraction advantage of the convolutional layer. In addition, the ME-DACAE model achieves highest accuracy in most tasks, and is only slightly inferior to the MTCAE-FT in a 5-shot task under the 750 rpm operating condition. However, the MTCAE-FT relies on a large amount of source domain data to assist training, while the ME-DACAE only requires scarce target data, avoiding additional cost, possessing both cost-effectiveness and effectiveness, and being more suitable for small sample fault diagnosis problems in the engineering practice.

### (2) Ablation Experiment of the Method of the Present Disclosure:

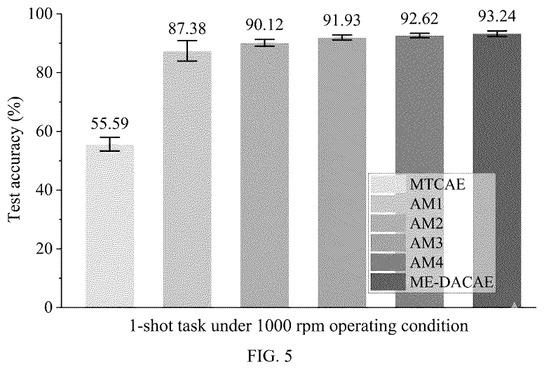

An ablation experiment is designed using the FST dataset to investigate effects of a multi-scale encoding strategy, a multi-scale decoding strategy, and the adversarial training strategy on model performance. Based on the ME-DACAE, a total of 4 ablation models are designed, identified as AM1 to AM4 respectively. AM1 only contains a single-scale encoder and decoder; AM2 combines a multi-scale encoder (covering 5 scales) and a single-scale decoder; AM3 is contrary to AM2 and adopts a single-scale encoder and a multi-scale decoder (covering 5 scales); and AM4 integrates the multi-scale encoder and decoder simultaneously; and the ME-DACAE adds the cooperative adversarial module on a basis of AM4. FIG. 5 shows test accuracy obtained by each ablation model and the ME-DACAE in a 1-shot task under a 1000 rpm operating condition. In addition, experimental results of the MTCAE (shown in FIG. 4) are also added to FIG. 5 for comparison. The experimental results show that both the multi-scale encoding and decoding strategies help to improve detection and diagnosis effects of the model. Compared with AM1, test accuracy of AM2 and AM3 is improved by 2.74% and 4.55% respectively, while AM4 is further improved on this basis, indicating that adopting both strategies simultaneously is more effective than using either strategy alone. The multi-scale encoder enhances data through feature fusion, and the multi-scale decoder integrates information of each scale to generate a better decoded sample. Compared with AM4, accuracy of the ME-DACAE is improved by 0.62%, verifying effectiveness of an adversarial module in the new fault detection and the known fault diagnosis. In addition, accuracy of AM1 is significantly higher than that of the MTCAE, indicating that the wavelet scattering transform has a positive effect on the model performance under a small sample condition.

The embodiments described above are only descriptions of preferred modes of the present disclosure, and do not limit the scope of the present disclosure. Various variations and improvements made by a person of ordinary skill in the art to the technical solutions of the present disclosure without departing from the design spirit of the present disclosure shall fall within the scope of protection determined by the claims of the present disclosure.

What is claimed is:

1. A poor information fault prediction method based on multi-domain feature fusion and an interpretable adversarial convolutional encoding network, comprising:
collecting a vibration signal of target rotating machinery;
inputting the vibration signal into a preset fault prediction model and outputting a fault category, wherein the fault category includes a known fault category and a new fault category, the fault prediction model is obtained based on training set training, the training set includes fault samples of a plurality of rotating machinery under multiple operating conditions, and the fault prediction model is constructed by combining multi-domain feature fusion and the interpretable adversarial convolutional encoding network;
wherein the fault prediction model includes:
a new fault detection module configured to perform multi-scale feature fusion on input data based on an autoencoder, obtain encoded data, and input the encoded data into a decoder to output decoded data, wherein the autoencoder is constructed using a wavelet scattering transform with different scales and a convolution module, and the decoder is constructed using a deconvolution module with different scales;
a known fault diagnosis module configured to input the encoded data into a classifier and output a prediction vector, wherein the classifier is constructed by a fully connected neural network;
a cooperative adversarial module configured to input the encoded data into an encoding discriminator, input the decoded data into a decoding discriminator, and perform model optimization using an adversarial training strategy; and
a fault output module configured to calculate a reconstruction error between the input data and the decoded data, and determine the fault category based on the reconstruction error, wherein if the reconstruction error reaches a preset threshold, determining as the new fault category, and if the reconstruction error does not reach the preset threshold, determining as a known fault category corresponding to a maximum component in the prediction vector;
wherein the encoded data is:
$$E ( x ) = \frac{1}{{J}_{E}} {\sum }_{j = 1}^{{J}_{E}} {F}_{C}^{( j )} ( {F}_{S}^{( j )} ( x ) ) ;$$
wherein E represents the autoencoder, x represents the input data, E(x) represents the encoded data,
$${F}_{S}^{( j )}$$
and
$${F}_{C}^{( j )}$$
represent the wavelet scattering transform and the convolution module having j-th scale information respectively, and J_{E} represents a number of scales included in the autoencoder;
wherein the decoded data is:
$$D ( E ( x ) ) = \frac{1}{{J}_{D}} {\sum }_{k = 1}^{{J}_{D}} {F}_{TC}^{( k )} ( E ( x ) ) = \frac{1}{{J}_{D}} {\sum }_{k = 1}^{{J}_{D}} {F}_{TC}^{( k )} ( \frac{1}{{J}_{E}} {\sum }_{j = 1}^{{J}_{E}} {F}_{C}^{( j )} ( {F}_{S}^{( j )} ( x ) ) ) ;$$
wherein D represents the decoder, D(E(x)) represents the decoded data,
$${F}_{TC}^{( k )}$$
represents the deconvolution module having k-th scale information, and J_{D} represents a number of scales included in the decoder;
wherein an objective function for performing the model optimization using the adversarial training strategy is:
$${Obj}_{ae , dsc} = \frac{1}{m} {\sum }_{i = 1}^{m} \frac{1}{{J}_{D}} {\sum }_{k = 1}^{{J}_{D}} {L}_{ae} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ;$$
wherein E, D, P_{E} and P_{D} represent the autoencoder, the decoder, the encoding discriminator, and the decoding discriminator respectively;
$${F}_{TC}^{( k )}$$
represents the deconvolution module having the k-th scale information; J_{D} represents the number of scales included in the decoder; Lₐₑ is a mean squared error loss function used by the autoencoder; L_{dsc} is a binary cross-entropy loss function used by the encoding discriminator or the decoding discriminator; xᵢ represents i-th input data; m represents a total number of input data; E(xᵢ) and
$${x}_{i}^{z}$$
represent encoded data and pseudo encoded data of the i-th input data respectively; and D(E(xᵢ)) and
$$D ( {x}_{i}^{z} )$$
represent decoded data and pseudo decoded data of the-th input data respectively.

2. The poor information fault prediction method based on multi-domain feature fusion and an interpretable adversarial convolutional encoding network according to claim 1, wherein before training the fault prediction model based on the training set, the method further includes performing preprocessing on the training set, and performing the preprocessing includes:
performing segmentation on the collected fault samples, and performing normalization.

3. The poor information fault prediction method based on multi-domain feature fusion and an interpretable adversarial convolutional encoding network according to claim 1, wherein optimizing the autoencoder is represented as:
$$F ( {θ}_{ae} , {b}_{ae} ) = {arg min}_{{θ}_{ae} , {b}_{ae}} \frac{1}{m} {\sum }_{i = 1}^{m} \frac{1}{{J}_{D}} {\sum }_{k = 1}^{{J}_{D}} {L}_{ae} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ;$$
wherein θₐₑ and bₐₑ represent various weights and bias parameters involved in the autoencoder respectively.

4. The poor information fault prediction method based on multi-domain feature fusion and an interpretable adversarial convolutional encoding network according to claim 1, wherein optimizing the encoding discriminator or the decoding discriminator is represented as:
$$F ( {θ}_{dsc} , {b}_{dsc} ) = {arg max}_{{θ}_{dsc} , {b}_{dsc}} \frac{1}{m} {\sum }_{i = 1}^{m} \frac{1}{{J}_{D}} {\sum }_{k = 1}^{{J}_{D}} {L}_{ae} ( {x}_{i} , {F}_{TC}^{( k )} ( E ( {x}_{i} ) ) ) - {L}_{dsc} ( {P}_{E} ( E ( {x}_{i} ) ) , 1 ) - {L}_{dsc} ( {P}_{E} ( {x}_{i}^{z} ) , 0 ) - {L}_{dsc} ( {P}_{D} ( D ( E ( {x}_{i} ) ) ) , 1 ) - {L}_{dsc} ( {P}_{D} ( D ( {x}_{i}^{z} ) ) , 0 ) ;$$
wherein θ_{dsc} and b_{dsc} represent various weights and bias parameters included in the encoding discriminator or the decoding discriminator respectively.

5. The poor information fault prediction method based on multi-domain feature fusion and an interpretable adversarial convolutional encoding network according to claim 1, wherein optimizing the classifier is represented as:
$$F ( {θ}_{cls} , {b}_{cls} ) = {arg min}_{{b}_{cls} , {θ}_{cls}} \frac{1}{m} {\sum }_{i = 1}^{m} {L}_{cls} ( C ( E ( {x}_{i} ) ) , {y}_{i} ) ;$$
wherein C represents the classifier, θ_{cls} and b_{cls} represent various weights and bias parameters included in the classifier respectively, L_{cls} is a cross-entropy loss function used by the classifier, C(E(xᵢ)) represents a predicted category of the i-th input data, and yᵢ represents a true category of the i-th input data.
